(19) United States
(12) Patent Application Publication
(10) Pub. No.: US 2003/0117442 A1
(43) Pub. Date: Jun. 26, 2003

(54) Dynamic indication for capacitor charging status

(76) Inventors: Yuemean Chen, Plymouth, MN (US); Scott Koelsch, Edina, MN (US); Kurt W. Papke, Chanhassen, MN (US)

Correspondence Address: MEDTRONIC, INC., 710 MEDTRONIC PARKWAY NE, MS-LC340, MINNEAPOLIS, MN, 55432-5604, US

(21) Appl. No.: 10/033,833

(22) Filed: Dec. 26, 2001

(51) Int. Cl. G09G 5/00

(52) U.S. Cl. 345/772

(57) ABSTRACT

A displayable interactive screen implemented to display the charging status of a capacitor in an implantable medical device. The display includes real time representation of voltage from start to target, tracking of elapsed time, status of charging circuit and a progress bar. The charging system may be terminated by a cancel button which remains active from the start to the end of the charging cycle. The displayable screen is a programmer or a PC in data communication with the programmer.

### FIELD OF THE INVENTION

The present invention generally relates to implantable medical devices. Specifically, the invention relates to capacitor and energy systems used in implantable medical devices. More specifically, the invention relates to a software system that provides a graphical display to inform users about capacitor and energy status in a medical device.

### BACKGROUND OF THE INVENTION

Various medical devices use capacitors, batteries, as well as other power source systems. Current practice requires that capacitor charging systems and power source conditions be reviewed and monitored continuously to ensure adequate power supply for a medical device. Since most medical devices, especially implanted medical devices, perform critical life sustaining functions, it is extremely important to ensure the availability of power to enable the proper operation of the medical device, either on a continuous or on as needed basis.

With regard to the prior art, U.S. Pat. No. 5,879,374 to Powers et al., discloses an external defibrillator with automatic, self-testing prior to use system. Specifically, this system performs functional tests and calibration verification tests automatically in response to test signals generated periodically and/or in response to predetermined conditions or events and indicates the test results visually and audibly.

U.S. Pat. No. 5,873,893 to Sullivan et al., discloses a method and apparatus for verifying the integrity of an output circuit before and during application of a distal relation pulse. Specifically, the integrity of an output circuit and output switches is determined by selectively monitoring changes in the voltage level on the energy storage capacitor.

U.S. Pat. No. 5,243,975 to Alferness et al., discloses a defibrillator with user interactive screen display. In accordance with this invention, the defibrillator is designed to determined and display the current, energy, relating to the magnitude of the selected energy level of the defibrillation pulse, and the magnitude of the current level of the defibrillation pulse.

U.S. Pat. No. 5,115,807 to Pless et al., discloses a programmable defibrillator with pulse energy and resistance displays and method of operating the same. Specifically, the invention relates to display information including the energy delivered and the resistance in the patient. In addition, the apparatus also displays information regarding energy which is expected to be delivered based on the entered parameters.

U.S. Pat. No. 5,741,340 to Kroll, relates to a method for determining an ICD replacement time. Specifically, the invention relates to a method of determining the recommended replacement time (RRT) and therefore extending longevity of implantable electronic medical devices. In a preferred embodiment, terminal battery voltage and capacitor charge time are independently monitored. If the terminal battery voltage falls below a predetermined threshold, or the capacitor charge time is confirmed to exceed a predetermined maximum charge time, an RRT signal is issued. In an alternative embodiment, an RRT signal is also issued by the medical device when one indicator of battery strength, for example, battery term voltage, falls below a predetermined intermediate voltage, but is above the minimum threshold voltage, and a second indicator of battery strength, for example, capacitor charge time exceeds its predetermined maximum threshold.

U.S. Pat. No. 5,748,427 to St. Vincent et al., discloses detecting failure of relay between storage capacitors and load. The invention generally relates to monitoring voltage on capacitors following opening of relay after administering discharge voltage pulse and comparing the voltage with a given threshold.

U.S. Pat. No. 5,453,698 to Archer, S. T. et al, discloses HV output stage and HV output leads integrity determination method for implantable defibrillator. The invention utilizes low voltage pulse of about 10 to 20 volts through a high volt output stage and subsequent measurements of residual voltages which is compared to reference voltage process the integrity of the device.

These and similar teachings in the prior art, especially as related to implantable medical device capacitor charging status, have been limited to charge/no charge only. Clearly, this does not give users much information about the capacitor. Accordingly, there is a need to provide users with real-time capacitor battery, energy and other related operational information of an implanted medical device to promote safety, reliability proper use and maintenance of the implanted medical device.

### SUMMARY OF THE INVENTION

The present invention relates to an interactive software system implemented in an implanted medical device to provide a preferably displayable information to users about, inter alia, the implanted medical device capacitor/energy status, including instructions to start charging, information about charging status, and current or initial voltage/energy level.

In accordance with the present invention, a graphical user interface is implemented to display capacitor/energy related information for use by physicians, nurses, technicians and patients. For example, based on the anticipated device application, capacitor voltage or energy level will be displayed. Additionally, a continuous update of capacitor voltage during charging, including charge elapsed time and charging circuit status will be part of the information package preferably displayed in a graphical display.

The software system of the present invention includes both automatic and user initiated interactive displays that would show various parameters relating to capacitor and energy status. For example, the user may request information on a capacitor reform, shock delivery and similar information, using a dialog box that is designed to pop up to indicate current capacitor status. The invention includes various other related features including, but not limited to, providing users with a graphical display to indicate current capacitor status and information about capacitor starting and target levels. Further, the display provides current capacitor energy level in real time. This is an important data to have, for example, to be able to know the energy that could be anticipated by a user at an upcoming shock delivery event. Other critical information inlcuding time elapsed for charging a capacitor, and whether or not charging time is much longer than expected are important indications of battery and circuit integrity, among other things.

### BRIEF DESCRIPTION OF THE DRAWINGS

FIG. 1 is an illustration of a body implantable device system in accordance with one embodiment of the invention, including hermetically-sealed device implanted in a patient and an external programmer unit communicating with the implanted medical device.

FIG. 2 is a view of the external programming unit of FIG. 1.

FIG. 3 is a block diagram of the implanted medical device system of FIG. 1.

FIG. 4 is an outline of a display for a capacitor charging status.

FIG. 5 is a logic flow diagram relating to the software system that operates the capacitor charging status's screen.

### DETAILED DESCRIPTION OF THE PREFERRED EMBODIMENTS

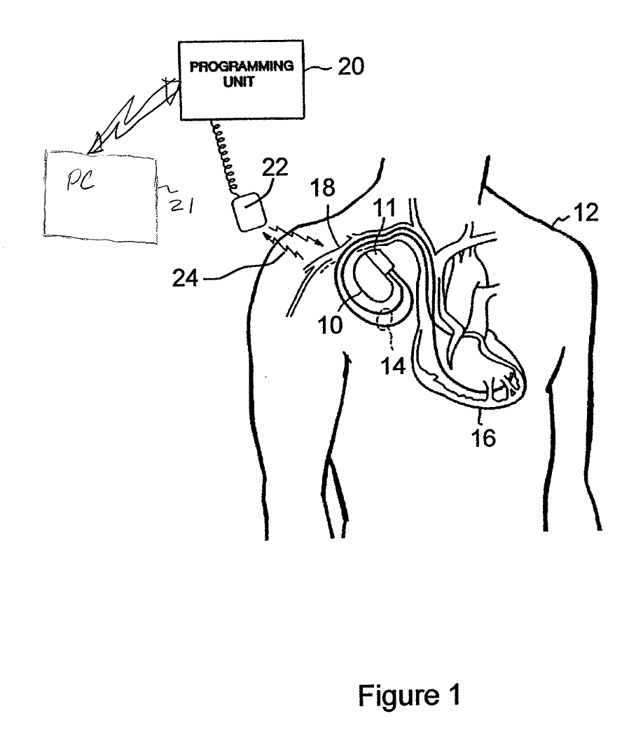

FIG. 1 is an illustration of an implantable medical device system adapted for use in accordance with the present invention. The medical device system shown in FIG. 1 includes an implantable device 10—a pacemaker in this embodiment—which has been implanted in a patient 12. In accordance with conventional practice in the art, pacemaker 10 is housed within a hermetically sealed, biologically inert outer casing, which may itself be conductive so as to serve as an indifferent electrode in the pacemaker's pacing/sensing circuit. One or more pacemaker leads, collectively identified with reference numeral 14 in FIG. 1 are electrically coupled to pacemaker 10 in a conventional manner and extend into the patient's heart 16 via a vein 18. Disposed generally near the distal end of leads 14 are one or more exposed conductive electrodes for receiving electrical cardiac signals and/or for delivering electrical pacing stimuli to heart 16. As will be appreciated by those of ordinary skill in the art, leads 14 may be implanted with its distal end situated in the atrium and/or ventricle of heart 16.

Although the present invention will be described herein in one embodiment which includes a pacemaker, those of ordinary skill in the art having the benefit of the present disclosure will appreciate that the present invention may be advantageously practiced in connection with numerous other types of implantable medical device systems, and indeed in any application in which it is desirable to provide a communication link between two physically separated components, such as may occur during transtelephonic monitoring.

Also depicted in FIG. 1 is an external programming unit 20 for non-invasive communication with implanted device 10 via uplink and downlink communication channels 24, to be hereinafter described in further detail. Associated with programming unit 20 is a programming head 22, in accordance with conventional medical device programming systems, for facilitating two-way communication between implanted device 10 and programmer 20. Further, PC 21 is in wireless data communication with programmer 20. PC 21 could communicate with programmer 20 via a modem, telemetry or similar wireless data communication system, for example, to transfer displayable data to a remote location for review of displayed data by experts at a remote control site. In many known implantable device systems, a programming head such as that depicted in FIG. 1 is positioned on the patient's body over the implant site of the device, such that one or more antennae within the head can send RF signals to, and receive RF signals from, an antenna disposed within the hermetic enclosure of the implanted device or disposed within the connector block of the device, in accordance with common practice in the art.

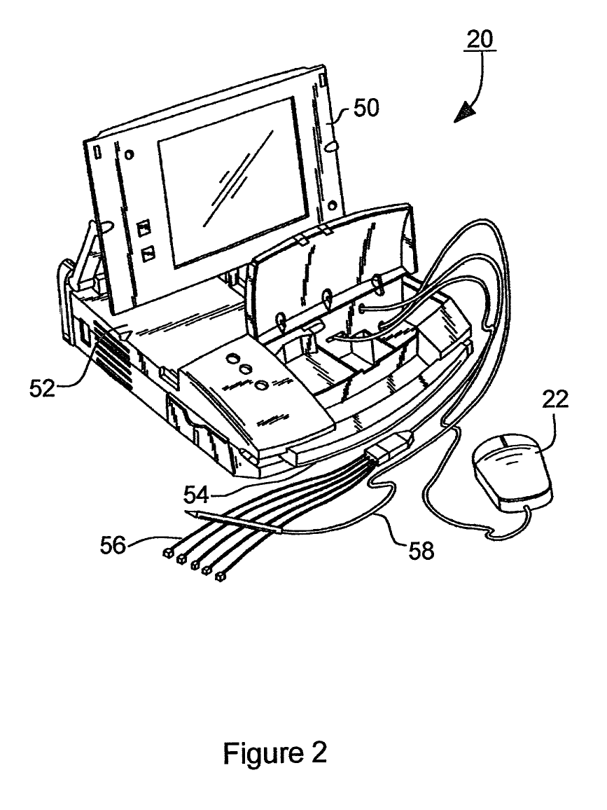

In FIG. 2, there is shown a perspective view of programming unit 20 in accordance with the presently disclosed invention. Internally, programmer 20 includes a processing unit (not shown in the Figures) that in accordance with the presently disclosed invention is a personal computer type motherboard, e.g., a computer motherboard including an Intel Pentium 3 microprocessor and related circuitry such as digital memory. The details of design and operation of the programmer's computer system will not be set forth in detail in the present disclosure, as it is believed that such details are well-known to those of ordinary skill in the art.

Referring to FIG. 2, programmer 20 comprises an outer housing 52, which is preferably made of thermal plastic or another suitably rugged yet relatively lightweight material. A carrying handle, designated generally as 54 in FIG. 2, is integrally formed into the front of housing 52. With handle 54, programmer 20 can be carried like a briefcase.

An articulating display screen 50 is disposed on the upper surface of housing 52. Display screen 50 folds down into a closed position (not shown) when programmer 20 is not in use, thereby reducing the size of programmer 20 and protecting the display surface of display 50 during transportation and storage thereof.

A floppy disk drive is disposed within housing 52 and is accessible via a disk insertion slot (not shown). A hard disk drive is also disposed within housing 52, and it is contemplated that a hard disk drive activity indicator, (e.g., an LED, not shown) could be provided to give a visible indication of hard disk activation.

Those with ordinary skill in the art would know that it is often desirable to provide a means for determining the status of the patient's conduction system. Normally, programmer 20 is equipped with external ECG leads 54. It is these leads which are rendered redundant by the present invention.

In accordance with the present invention, programmer 20 is equipped with an internal printer (not shown) so that a hard copy of a patient's ECG or of graphics displayed on the programmer's display screen 50 can be generated. Several types of printers, such as the AR-100 printer available from General Scanning Co., are known and commercially available.

In the perspective view of FIG. 2, programmer 20 is shown with articulating display screen 50 having been lifted up into one of a plurality of possible open positions such that the display area thereof is visible to a user situated in front of programmer 20. Articulating display screen is preferably of the LCD or electro-luminescent type, characterized by being relatively thin as compared, for example, a cathode ray tube (CRT) or the like.

Display screen 50 is operatively coupled to the computer circuitry disposed within housing 52 and is adapted to provide a visual display of graphics and/or data under control of the internal computer.

Programmer 20 described herein with reference to FIG. 2 is described in more detail in U.S. Pat. No. 5,345,362 issued to Thomas J. Winkler, entitled “Portable Computer Apparatus With Articulating Display Panel,” which patent is hereby incorporated herein by reference in its entirety. The Medtronic Model 9790 programmer is the implantable device-programming unit with which the present invention may be advantageously practiced.

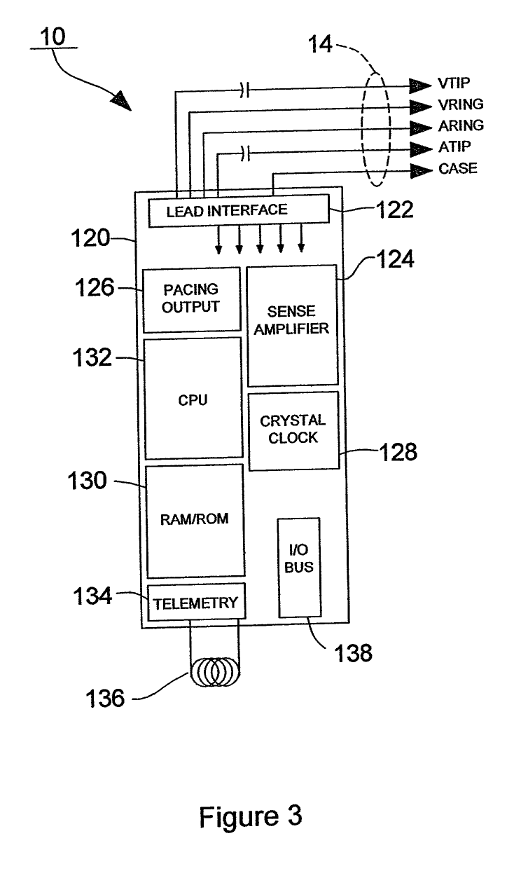

FIG. 3 is a block diagram of the electronic circuitry that makes up pulse generator 10 in accordance with the presently disclosed invention. As can be seen from FIG. 3, pacemaker 10 comprises a primary stimulation control circuit 120 for controlling the device's pacing and sensing functions. The circuitry associated with stimulation control circuit 120 may be of conventional design, in accordance, for example, with what is disclosed U.S. Pat. No. 5,052,388 issued to Sivula et al., “Method and apparatus for implementing activity sensing in a pulse generator.” To the extent that certain components of pulse generator 10 are conventional in their design and operation, such components will not be described herein in detail, as it is believed that design and implementation of such components would be a matter of routine to those of ordinary skill in the art. For example, stimulation control circuit 120 in FIG. 3 includes sense amplifier circuitry 124, stimulating pulse output circuitry 126, a crystal clock 128, a random-access memory and read-only memory (RAM/ROM) unit 130, and a central processing unit (CPU) 132, all of which are well-known in the art.

Pacemaker 10 also includes internal communication circuit 134 so that it is capable of communicating with external programmer/control unit 20, as described in FIG. 2 in greater detail.

With continued reference to FIG. 3, pulse generator 10 is coupled to one or more leads 14 which, when implanted, extend transvenously between the implant site of pulse generator 10 and the patient's heart 16, as previously noted with reference to FIG. 1. Physically, the connections between leads 14 and the various internal components of pulse generator 10 are facilitated by means of a conventional connector block assembly 11, shown in FIG. 1. Electrically, the coupling of the conductors of leads and internal electrical components of pulse generator 10 may be facilitated by means of a lead interface circuit 122 which functions, in a multiplexer-like manner, to selectively and dynamically establish necessary connections between various conductors in leads 14, including, for example, atrial tip and ring electrode conductors ATIP and ARING and ventricular tip and ring electrode conductors VTIP and VRING, and individual electrical components of pulse generator 10, as would be familiar to those of ordinary skill in the art. For the sake of clarity, the specific connections between leads 14 and the various components of pulse generator 10 are not shown in FIG. 3, although it will be clear to those of ordinary skill in the art that, for example, leads 14 will necessarily be coupled, either directly or indirectly, to sense amplifier circuitry 124 and stimulating pulse output circuit 126, in accordance with common practice, such that cardiac electrical signals may be conveyed to sensing circuitry 124, and such that stimulating pulses may be delivered to cardiac tissue, via leads 14. Also not shown in FIG. 3 is the protection circuitry commonly included in implanted devices to protect, for example, the sensing circuitry of the device from high voltage stimulating pulses.

As previously noted, stimulation control circuit 120 includes central processing unit 132 which may be an off-the-shelf programmable microprocessor or micro controller, but in the present invention is a custom integrated circuit. Although specific connections between CPU 132 and other components of stimulation control circuit 120 are not shown in FIG. 3, it will be apparent to those of ordinary skill in the art that CPU 132 functions to control the timed operation of stimulating pulse output circuit 126 and sense amplifier circuit 124 under control of programming stored in RAM/ROM unit 130. It is believed that those of ordinary skill in the art will be familiar with such an operative arrangement.

With continued reference to FIG. 3, crystal oscillator circuit 128, in the presently preferred embodiment a 32,768-Hz crystal controlled oscillator, provides main timing clock signals to stimulation control circuit 120. Again, the lines over which such clocking signals are provided to the various timed components of pulse generator 10 (e.g., microprocessor 132) are omitted from FIG. 3 for the sake of clarity.

It is to be understood that the various components of pulse generator 10 depicted in FIG. 3 are powered by means of a battery (not shown) which is contained within the hermetic enclosure of pacemaker 10, in accordance with common practice in the art. For the sake of clarity in the Figures, the battery and the connections between it and the other components of pulse generator 10 are not shown.

Stimulating pulse output circuit 126, which functions to generate cardiac stimuli under control of signals issued by CPU 132, may be, for example, of the type disclosed in U.S. Pat. No. 4,476,868 to Thompson, entitled “Body Stimulator Output Circuit,” which patent is hereby incorporated by reference herein in its entirety. Again, however, it is believed that those of ordinary skill in the art could select from among many various types of prior art pacing output circuits that would be suitable for the purposes of practicing the present invention.

Sense amplifier circuit 124, which is of conventional design, functions to receive electrical cardiac signals from leads 14 and to process such signals to derive event signals reflecting the occurrence of specific cardiac electrical events, including atrial contractions (P-waves) and ventricular contractions (R-waves). CPU provides these event-indicating signals to CPU 132 for use in controlling the synchronous stimulating operations of pulse generator 10 in accordance with common practice in the art. In addition, these event-indicating signals may be communicated, via uplink transmission, to external programming unit 20 for visual display to a physician or clinician.

Those of ordinary skill in the art will appreciate that pacemaker 10 may include numerous other components and subsystems, for example, activity sensors and associated circuitry. The presence or absence of such additional components in pacemaker 10, however, is not believed to be pertinent to the present invention, which relates primarily to the implementation and operation of communication subsystem 134 in pacemaker 10, and an associated communication subsystem in external unit 20.

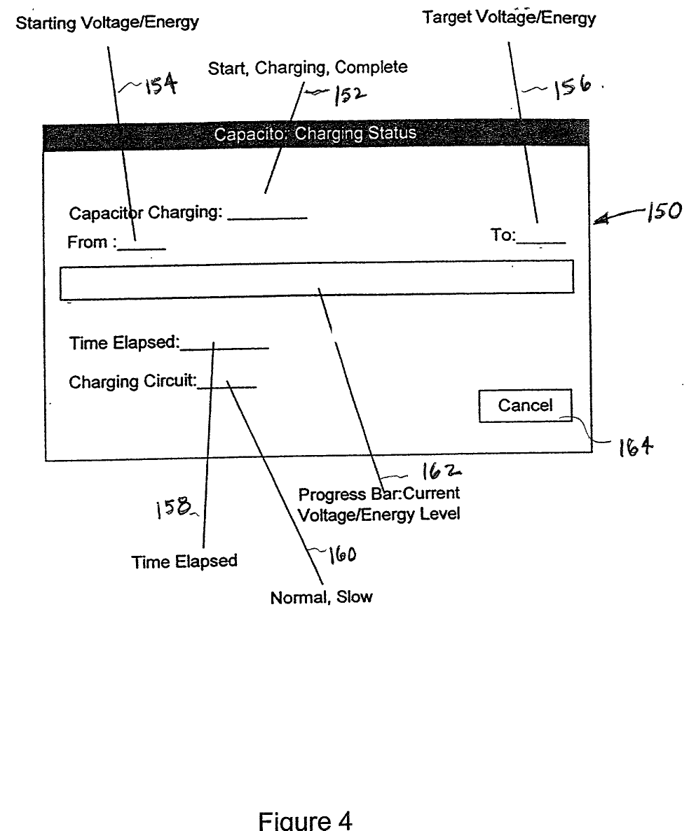

Referring to FIG. 4, a dialog box in accordance with the present invention is shown. Specifically, the dialog box provides information relating to capacitor battery charging, starting voltage and energy, target voltage and energy, the time elapsed, as well as whether or not the charging circuit is normal or slow. As discussed hereinabove, pulse generator 10 includes a power pack such as batteries and capacitors to provide the pulse as needed. The software system of the present invention is incorporated with CPU 132 to provide capacitor status as needed. The display may be shown on programming unit 20 or a PC screen. The status displays may also be exported to a remote location via the programming unit 20 or equivalent to be reviewed remotely.

More specifically, dialog box 150 includes a status indicating screen wherein capacitor charging, including the start time, whether or not the capacitor is charging, or if charging is completed, is shown at Section 152 on the screen. Further, starting voltage or energy is indicated at Section 154 and target voltage or the energy to which the capacitor is required or programmed to charge, is indicated at Section 156. The time elapsed from initiation of the charging process up to the point of termination is indicated at Section 158 of screen 150. Similarly, the charging circuit status is monitored and indicated at Section 160 to indicate whether the circuit is normal or slow. Throughout the charging process, a progress bar is displayed at Section 162 to inform users of the charging status relating to the desired voltage and energy level, preferably, the bar would have a percentage display wherein the percentage relates to the level of charge reached at any lapsed time.

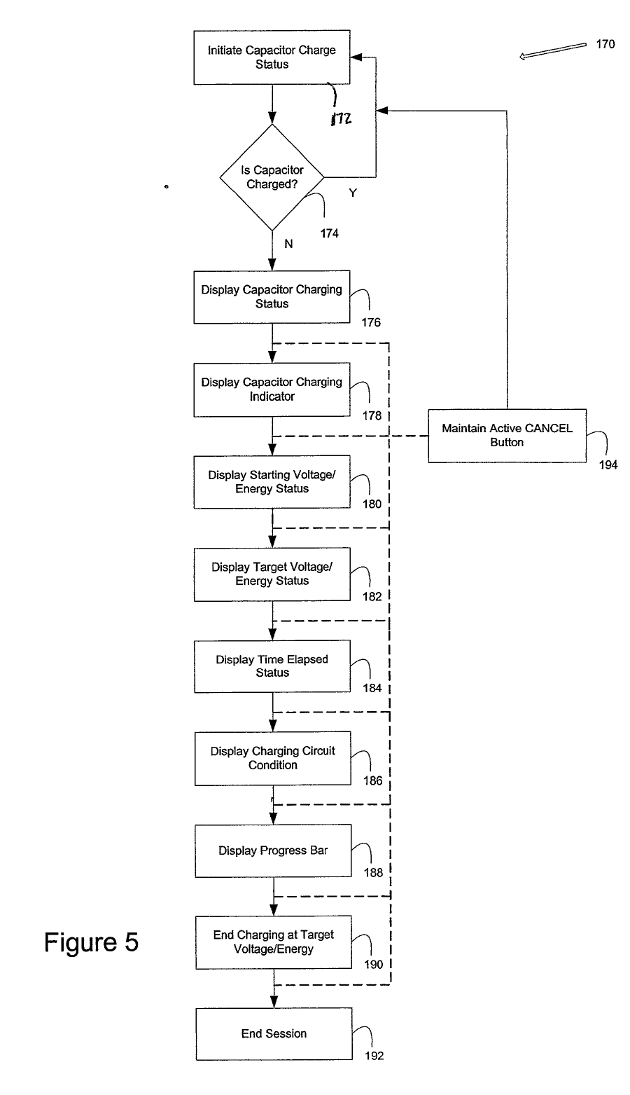

FIG. 5 illustrates the logical process under which the software system implemented in the present invention operates. Specifically, logic flow chart 170 is initiated at step 172. Subsequent to initiation, the logic flow continues to decision step 174, wherein whether the capacitor is charged or not is confirmed. If the capacitor is confirmed charged, then the logic enters a subroutine where it idles until another initiation command is executed. In the alternate, if the capacitor is not charged, the capacitor charging screen is activated and displayed with the various elements therein under step 176. Specifically, under step 178, the capacitor charging indicator is implemented to indicate the start charging and completion of charge during the charging process. If the capacitor is charging, the starting voltage or energy is displayed under step 180 and the target voltage or energy is displayed under step 182. Further, under step 184, the elapsed time since the start of the charge is displayed. The condition of the charging circuit, whether it is normal or slow, is displayed under step 186. All of these displays are integrated under step 188 where a progress bar monitors and displays in real-time the voltage and energy level and its relation with the start and target voltage or energy, such that at any time elapsed, the user may be able to monitor the status of the charge. When the target voltage of energy is reached, the charging is ended at logic step 190 and the decision is terminated at step 192. Further, a cancel button is maintained active simultaneous with the initiation of the capacitor charge at step 172 to enable termination at any one of the subsequent steps discussed hereinabove.

While particular embodiments have been shown and described herein, it will be apparent to those skilled in the art that variations and modifications may be made in these embodiments without departing from the spirit and scope of the invention. It is the purpose of the appended claims to cover any and all such variations and modifications.

What is claimed is:

1. A software system in cooperation with a medical device microprocessor and circuitry to provide dynamic, real time display of capacitor and energy status, the software system comprising:
a graphical user interface indicating a plurality of status parameters;
means for initiating access to said plurality of status parameters; and
means for manifesting said dynamic, real time display of the status.

2. The software system of claim 1 wherein said means for manifesting includes a status bar indicative of current conditions of at least one of said plurality of status parameters.

3. The software system of claim 1 wherein a cancel button is activated at the start of said means for initiating access.

4. A software system implemented in conjunction with a microprocessor circuitry of a medical device, the software system comprising:
means for displaying a plurality of capacitor status parameters;
means for tracking voltage/energy level at anytime during charging; and
means for canceling a display at anytime during said charging.

5. The software system of claim 4 wherein said means for displaying includes charging circuit operation identified as normal or slow.

6. The software system of claim 4 wherein said means for tracking includes a charging status display of temporal voltage/energy level at any point during charging.

7. The software system of claim 4 wherein a capacitor charging status of a start, charging and complete condition are displayed based on the respective charging status of the capacitor.

8. A capacitor charging display, displayable on a screen, the display comprising:
means for displaying capacitor charging status;
means for displaying starting voltage/energy;
means for displaying target voltage/energy;
means for displaying elapsed time;
means for displaying charging circuit condition;
means for canceling charging operations; and
means for displaying the charging progress based on voltage/energy.

9. The display of claim 8 wherein the screen is a programmer screen.

10. The display of claim 8 wherein the screen is a PC screen.

11. The display of claim 9 wherein the screen is a PC screen remotely located from said programmer screen.

12. The display of claim 11 wherein said PC and programmer are connected in remote data communication therewith.
